(19) United States
(12) Patent Application Publication
(10) Pub. No.: US 2015/0028591 A1
(43) Pub. Date: Jan. 29, 2015

(54) VERTICAL AXIS WINDMILL WITH A DECELERATION CONTROL SYSTEM

(71) Applicant: HI-VAWT TECHNOLOGY CORP., Taipei (TW)

(72) Inventors: EDDY HSU, Taipei (TW); Chance WU, Taipei (TW); Moa-Hsiung HSU, Taipei (TW)

(73) Assignee: HI-VAWT TECHNOLOGY CORP., Taipei (TW)

(21) Appl. No.: 14/295,299

(22) Filed: Jun. 3, 2014

(30) Foreign Application Priority Data
Jul. 24, 2013 (TW) 102126403

(51) Int. Cl. H02P 3/02; F03D 9/00

(52) U.S. Cl. CPC H02P 3/02; F03D 9/002
USPC 290/44

(57) ABSTRACT

A vertical axis windmill with a deceleration control system includes: a stationary shaft, a rotary shaft rotatably sleeved onto the stationary shaft, plural blades fixed to the rotary shaft, and a generator disposed between the stationary shaft and the rotary shaft. The deceleration control system includes a damping plate, a magnetic-force generating unit, a rectifier, and a control unit. The magnetic-force generating unit generates an eddy current to produce a damping effect. The rectifier converts AC voltage outputted from the generator into DC voltage. The control unit is coupled between the rectifier and the magnetic-force generating unit and sets a conduction level. When the DC voltage is lower than the conduction level, the rectifier and the magnetic-force generating unit are electrically disconnected from each other, and when the DC voltage is greater than the conduction level, the rectifier and the magnetic-force generating unit are electrically connected to each other.

### BACKGROUND OF THE INVENTION

1. Field of the Invention

The present invention relates to a vertical axis windmill, and more particularly to a vertical axis windmill with a deceleration control system.

2. Description of the Prior Art

As shown in FIG. 1, a conventional vertical axis windmill 10 generally comprises a vertically-arranged stationary shaft 11, a rotary shaft 12 sleeved onto and rotatable with respect to the stationary shaft 11, and an external rotator generator 13 rotated by the rotary shaft 12. On the rotary shaft 12 are provided three pieces of Darrieus blades 14, and a barrel blade 15. Wind power pushes the blades 14, 15 to rotate the rotary shaft 12 and the external rotator generator 13, so that wind power is converted into electric energy by the external rotator generator 13.

The vertical axis windmill 10 is usually provided with a deceleration device (not shown) to prevent excessive rotation speed of the rotary shaft 12, which is likely to cause damage to the external rotator generator 13. The deceleration device employs a damping block to press against the stationary shaft 11 to reduce the rotation speed of the rotary shaft 12 by generating a friction force. However, the damping block will wear off and needs to be replaced at regular intervals.

Another method to control the rotation speed of the rotary shaft 12 is to repeatedly control the electromagnetic force inside the external rotator generator 13, which, however, is likely to cause damage or failure to the external rotator generator 13.

The present invention has arisen to mitigate and/or obviate the afore-described disadvantages.

### SUMMARY OF THE INVENTION

The primary objective of the present invention is to provide a vertical axis windmill with a deceleration control system capable of preventing excessive rotation of the rotary shaft, and thus preventing damage or failure to the generator. Besides, the components of the windmill do not require regular replacement within a short period of time.

To achieve the above objective, a vertical axis windmill with a deceleration control system in accordance with the present invention comprises: a stationary shaft; a rotary shaft rotatably sleeved onto the stationary shaft; a plurality of blades fixed to the rotary shaft; and a generator disposed between the stationary shaft and the rotary shaft and including a power output terminal. The deceleration control system includes a damping plate, a magnetic-force generating unit, a rectifier, and a control unit. The damping plate is made of metal and fixed on the rotary shaft. The magnetic-force generating unit is fixed on the stationary shaft and located adjacent to the damping plate. The magnetic-force generating unit, when powered on, generates an eddy current applied to the damping plate to produce a damping effect when the damping plate rotates along with the rotary shaft. The rectifier includes a rectifying input terminal coupled to the power output terminal of the generator, and a rectifying output terminal and serves to convert AC voltage outputted from the generator into DC voltage, and then the DC voltage is outputted from the rectifying output terminal. The control unit is coupled between the rectifying terminal and the magnetic-force generating unit and has a conduction level, when the DC voltage is lower than the conduction level, the rectifier and the magnetic-force generating unit are electrically disconnected from each other, and when the DC voltage is greater than the conduction level, the rectifier and the magnetic-force generating unit are electrically connected to each other.

Preferably, a range of the eddy current generated by the magnetic-force generating unit covers the damping plate.

Preferably, the magnetic-force generating unit includes a metal plate fixed on the stationary shaft and an even number of solenoids annularly arranged on the metal plate, in such a manner that each two neighboring solenoids has different polarities, and the eddy current produced by the solenoids is applied upward to the damping plate.

Preferably, the damping plate includes a disc portion fixed to the rotary shaft and an annular lateral portion extending downward from the disc portion, the magnetic-force generating unit includes a metal plate fixed on the stationary shaft and an even number of solenoids annularly arranged on the metal plate, in such a manner that each two neighboring solenoids has different polarities, and the eddy current produced by the solenoids is applied outward to the damping plate.

### BRIEF DESCRIPTION OF THE DRAWINGS

FIG. 1 is a side view of a conventional vertical axis windmill;

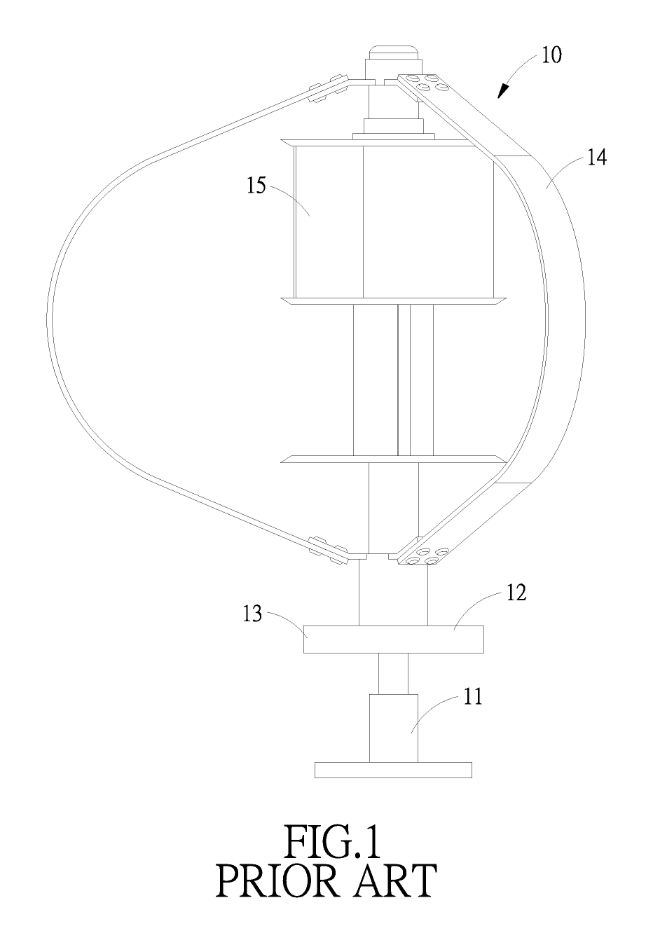

FIG. 2 is a side view of a vertical axis windmill with a deceleration control system in accordance with a first embodiment of the present invention;

FIG. 3 is an enlarged view of a part of FIG. 2;

FIG. 4 is a top view of a magnetic-force generating unit of the vertical axis windmill with a deceleration control system in accordance with the first embodiment of the present invention;

FIG. 5 is an illustrative view of the vertical axis windmill with a deceleration control system in accordance with the first embodiment of the present invention, wherein the control unit is disposed between the generator and the magnetic-force generating unit;

FIG. 6 is a side view of a vertical axis windmill with a deceleration control system in accordance with a second embodiment of the present invention; and

FIG. 7 is an enlarged view of a part of FIG. 6.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

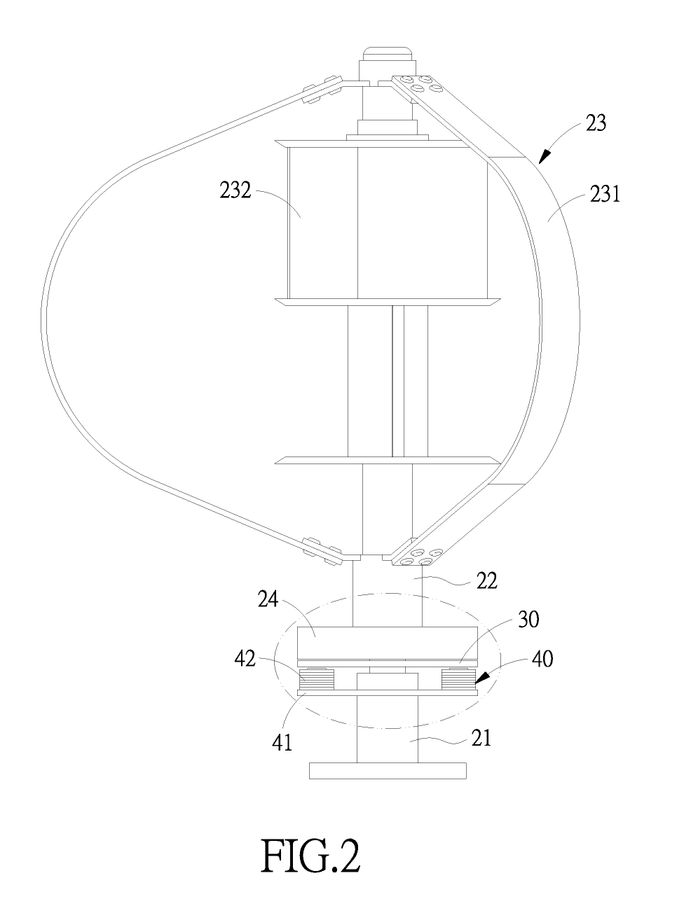

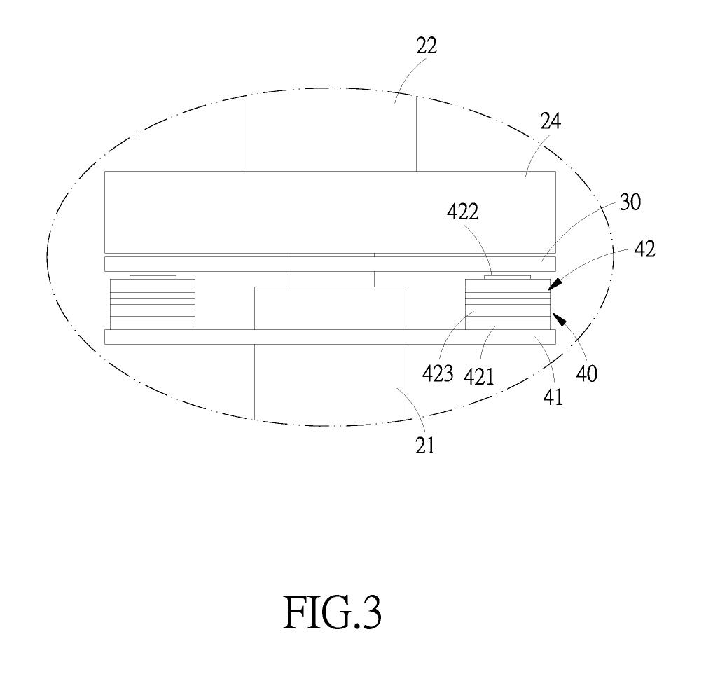

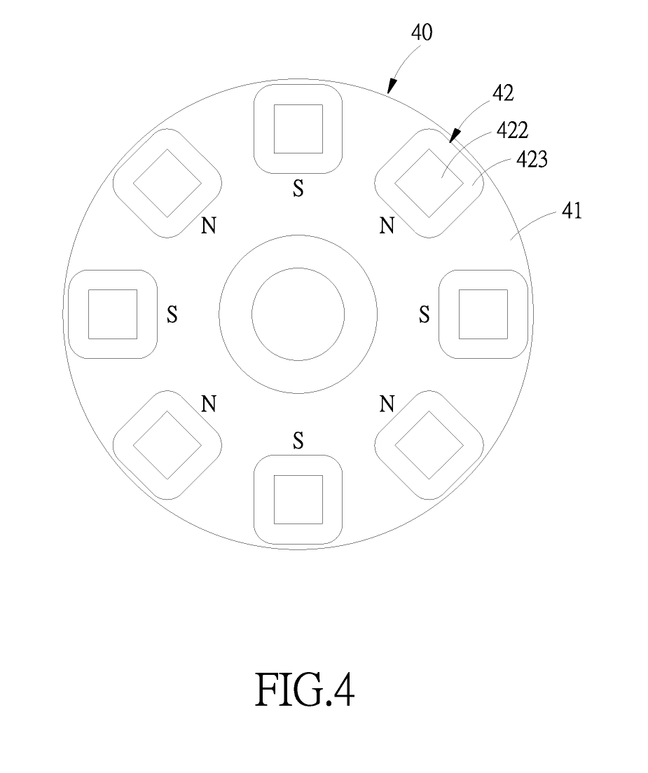

Referring to FIGS. 2-5, a vertical axis windmill with a deceleration control system in accordance with a first embodiment of the present invention comprises: a stationary shaft 21, a rotary shaft 22, a plurality of blades 23, a generator 24, and the deceleration control system.

The stationary shaft 21 is vertically arranged on the ground.

The rotary shaft 22 is rotatably sleeved on the stationary shaft 21.

The blades 23 are fixed to the rotary shaft 22. In this embodiment, the blades are three Darrieus blades 231 and a barrel blade 232.

The generator 24 is disposed between the stationary shaft 21 and the rotary shaft 22, and includes a power output terminal 241. In this embodiment, the generator 24 is an external rotator generator.

The deceleration control system includes a damping plate 30, a magnetic-force generating unit 40, a rectifier 50, and a control unit 60.

The damping plate 30 is made of metal and fixed on and rotates along with the rotary shaft 22.

The magnetic-force generating unit 40 is fixed on the stationary shaft 21 and located adjacent to the damping plate 30. The magnetic-force generating unit 40, when powered on, can generate an eddy current (magnetic resistance) to produce a damping effect when the damping plate 30 rotates along with the rotary shaft 22. In this embodiment, the range of the magnetic resistance generated by the magnetic-force generating unit 40 covers the damping plate 30, and the magnetic-force generating unit 40 includes a metal plate 41 fixed on the stationary shaft 21 and an even number of solenoids 42 annularly arranged on the metal plate 41, in such a manner that each two neighboring solenoids 42 has different polarities, and the eddy current produced by the solenoids 42 is applied upward to the damping plate 30. Each of the solenoids 42 includes a back iron 421, an iron core 422 disposed on the back iron 421, and a coil 423 wound around the iron core 422.

The rectifier 50 is a three-phase bridge rectifier with a rectifying input terminal 51 coupled to the power output terminal 241 of the generator 24, and a rectifying output terminal 52, so as to convert the AC voltage outputted from the generator 24 into DC voltage, and then the DC voltage is outputted from the rectifying output terminal 52.

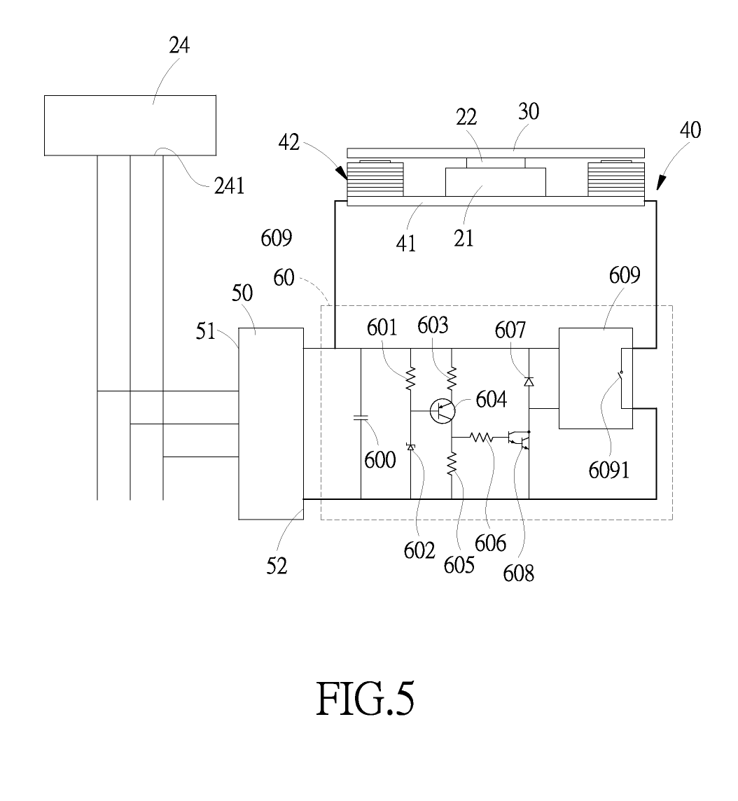

The control unit 60 is coupled between the rectifying output terminal 52 and the magnetic-force generating unit 40 and has a conduction level. When the DC voltage is lower than the conduction level, the rectifier 50 and the magnetic-force generating unit 40 are electrically disconnected from each other, and when the DC voltage is greater than the conduction level, the rectifier 50 and the magnetic-force generating unit 40 are electrically connected to each other. In this embodiment, the control unit 60 serves to detect the DC current outputted from the rectifying output terminal 52 of the rectifier 50. As shown in FIG. 5, The control unit 60 includes a capacitor 600, a first resistor 601, a Zener diode 602, a second resistor 603, a PNP transistor 604, a third resistor 605, a fourth resistor 606, a diode 607, a Darlington transistor 608, and a solid state relay 609. The capacitor 600 servers to filter the DC voltage outputted from the rectifying output terminal 52 of the rectifier 50. The first resistor 601, the second resistor 603, the third resistor 605, the PNP transistor 604 and the Zener diode 602 constitute an electronic switch. When the DC voltage outputted from the rectifier 50 is larger than the forward voltage of the Zener diode 602 plus 0.7 voltage, the PNP transistor 604 (V_{CE}=0.2V) will be powered on. After the PNP transistor 604 is powered on, current will flow through the fourth resistor 606 to the Darlington transistor 608, so that the Darlington transistor 608 is powered on (V_{CE}=0.2V). The power-on of the Darlington transistor 608 leads to the power on of the connection point 6091 of the solid state relay 609, so that the rectifier 50 and the magnetic-force generating unit 40 are electrically connected to each other. Then, the magnetic-force generating unit 40 receives the DC voltage outputted from the rectifier 50 to produce a magnetic resistance (eddy current) which is applied to the damping plate 30. Furthermore, the sum of the forward voltage of the Zener diode 602 plus 0.7 voltage is equal to the conduction level.

The voltage generated by the generator 24 is used as a reference level for deceleration, based on the principle that the rotation speed of the rotary shaft 22 of the windmill of the present invention is in direct proportion to the voltage generated from the generator 24. When the DC voltage generated from the generator 24 is greater than the predetermined conduction level, the rectifier 50 and the magnetic-force generating unit 40 are electrically connected to each other, so that the magnetic-force generating unit 40 will produce an eddy current applied to the damping plate 30 to produce a damping effect when the damping plate 30 rotates along with the rotary shaft 22. Namely, the rotation speed of the rotary shaft 22 is reduced to prevent damage or failure to the windmill caused by excessive rotation of the rotary shaft 22. Meanwhile, the top limit of the rotation speed of the windmill is raised, which consequently enhances the wind power utilization efficiency in the high speed region, and the annual average generating capacity. Besides, using the magnetic resistance to produce damping effect on the damping plate 30 won't cause wear of the relative components (namely, the components don't need to be regularly replaced), and won't cause damage or failure to the generator 24.

When the rotary shaft 22 decelerates, the voltage generated from the generator 24 will drop, and if the DC voltage detected by the control unit 60 is lowered than the conduction level, the rectifier 50 and the magnetic-force generating unit 40 will be electrically disconnected from each other, and thus the generator 24 can be driven to rotate without any resistance by the rotary shaft 22.

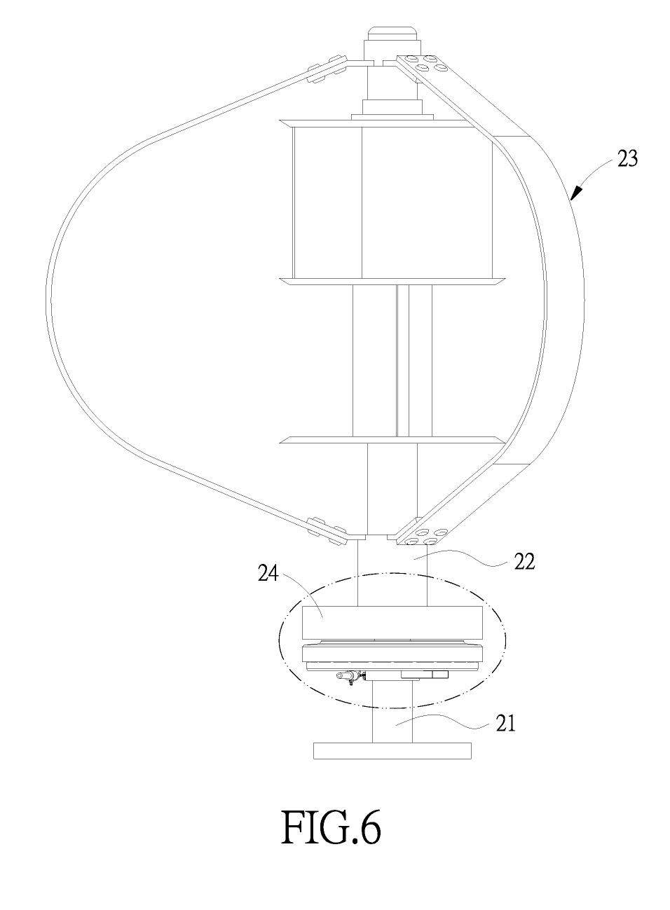

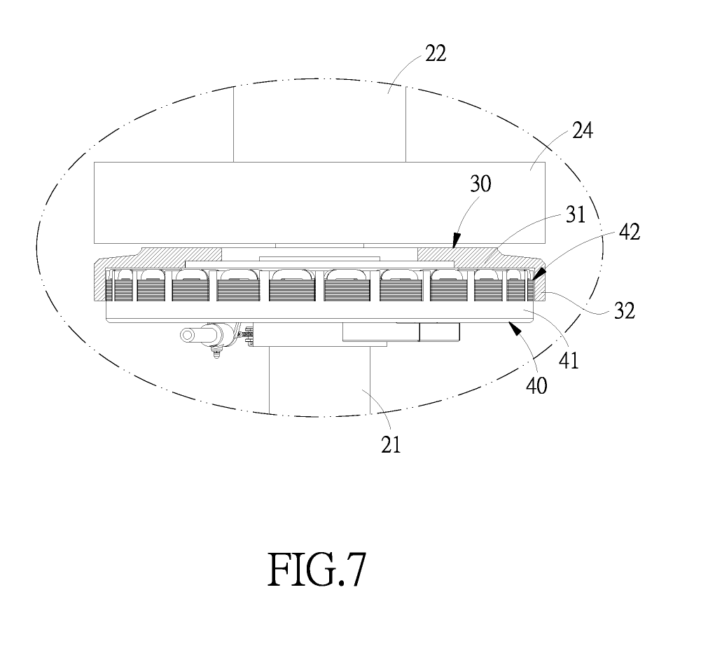

Referring then to FIGS. 6 and 7, a vertical axis windmill with a deceleration control system in accordance with a second embodiment of the present invention is similar to the first embodiment, except that:

The damping plate 30 includes a disc portion 31 fixed to the rotary shaft 22 and an annular lateral portion 32 extending downward from the disc portion 31. The magnetic-force generating unit 40 includes a metal plate 41 fixed on the stationary shaft 21 and an even number of solenoids 42 annularly arranged on the metal plate 41, in such a manner that each two neighboring solenoids 42 has different polarities, and the eddy current produced by the solenoids 42 is applied outward to the damping plate 30.

While we have shown and described various embodiments in accordance with the present invention, it is clear to those skilled in the art that further embodiments may be made without departing from the scope of the present invention.

What is claimed is:

1. A vertical axis windmill with a deceleration control system comprising:
a stationary shaft;
a rotary shaft rotatably sleeved onto the stationary shaft;
a plurality of blades fixed to the rotary shaft;
a generator disposed between the stationary shaft and the rotary shaft, and including a power output terminal; and
the deceleration control system including a damping plate, a magnetic-force generating unit, a rectifier, and a control unit; wherein
the damping plate is made of metal and fixed on the rotary shaft;
the magnetic-force generating unit is fixed on the stationary shaft and located adjacent to the damping plate, the magnetic-force generating unit, when powered on, generates an eddy current applied to the damping plate to produce a damping effect when the damping plate rotates along with the rotary shaft;
the rectifier includes a rectifying input terminal coupled to the power output terminal of the generator, and a rectifying output terminal, and serves to convert AC voltage outputted from the generator into DC voltage, and then the DC voltage is outputted from the rectifying output terminal;
the control unit is coupled between the rectifying terminal and the magnetic-force generating unit and has a conduction level, when the DC voltage is lower than the conduction level, the rectifier and the magnetic-force generating unit are electrically disconnected from each other, and when the DC voltage is greater than the conduction level, the rectifier and the magnetic-force generating unit are electrically connected to each other.

2. The vertical axis windmill with the deceleration control system as claimed in claim 1, wherein a range of the eddy current generated by the magnetic-force generating unit covers the damping plate.

3. The vertical axis windmill with the deceleration control system as claimed in claim 1, wherein the magnetic-force generating unit includes a metal plate fixed on the stationary shaft and an even number of solenoids annularly arranged on the metal plate, in such a manner that each two neighboring solenoids has different polarities, and the eddy current produced by the solenoids is applied upward to the damping plate.

4. The vertical axis windmill with the deceleration control system as claimed in claim 1, wherein the damping plate includes a disc portion fixed to the rotary shaft and an annular lateral portion extending downward from the disc portion, the magnetic-force generating unit includes a metal plate fixed on the stationary shaft and an even number of solenoids annularly arranged on the metal plate, in such a manner that each two neighboring solenoids has different polarities, and the eddy current produced by the solenoids is applied outward to the damping plate.
